(19) United States
(12) Patent Application Publication
(10) Pub. No.: US 2013/0159932 A1
(43) Pub. Date: Jun. 20, 2013

(54) PROCESSING DEVICE FOR SELECTING FILES CONVENIENTLY AND METHOD FOR SELECTING FILES CONVENIENTLY

(71) Applicant: ArcSoft Hangzhou Co., Ltd., Hangzhou City (CN)

(72) Inventors: Zhenhua Chen, Hangzhou City (CN); Mingjie Mao, Hangzhou City (CN)

(73) Assignee: ARCSOFT HANGZHOU CO., LTD., Hangzhou City (CN)

(21) Appl. No.: 13/685,723

(22) Filed: Nov. 27, 2012

(30) Foreign Application Priority Data
Dec. 16, 2011 (CN) 201110426042.8

(51) Int. Cl. G06F 3/0481

(52) U.S. Cl. CPC G06F 3/04817
USPC 715/835

(57) ABSTRACT

A processing device for selecting files conveniently includes a processor and a display panel. The processor is used for receiving a first open command of a user, a browse command, a browse end command, a select command, a second open command, and a processing command. The processor opens a folder on the display panel according to the first open command, displays at least one file of the folder on the display panel according to the browse command, selects the file browsed by the user currently to a selected file list according to the select command, closes the folder displayed on the display panel according to the browse end command, opens a selected file list on the display panel according to the second open command, and processes all selected files of the selected file list according to the processing command.

### BACKGROUND OF THE INVENTION

1. Field of the Invention

The present invention relates to a processing device for selecting files conveniently and method thereof, and particularly to a processing device for selecting files conveniently and method thereof that can quickly and conveniently select and process at least one file of a folder, instead of frequently switching between software and a system browser.

2. Description of the Prior Art

Much software can support opening a plurality of files simultaneously, and browsing the plurality of files one-by-one in single file. When a user opens a plurality of files of a folder through software, the user usually needs to select specific files, and the specific selected files are further processed during the user browsing the plurality of files of the folder one-by-one.

However, software provided by the prior art does not supply a direct method that can satisfy a requirement of the user browsing files of a folder and selecting specific files of the folder simultaneously. Therefore, for selecting or gathering files, the user only browses a file of the folder through the software, utilizes a system browser to find the file of the folder through corresponding information of the file provided by the software, and copies the file to a predetermined location (such as a system desktop or a new folder) to further process the file. Thus, frequent switching between the software and the system browser is very complicated and not easy to use for the user.

### SUMMARY OF THE INVENTION

An embodiment provides a method for selecting files conveniently. The method includes receiving a first open command of a user; opening a folder according to the first open command; receiving a browse command of the user; displaying at least one file of the folder on a display panel according to the browse command; and executing a corresponding operation according to whether a select command of the user is received when a browse end command of the user is not received.

Another embodiment provides a method for selecting files conveniently. The method includes receiving a first open command of a user; opening a folder according to the first open command; receiving a browse command of the user; displaying at least one file of the folder on a display panel according to the browse command; and executing a corresponding operation according to whether a second open command of the user is received when a browse end command of the user is received.

Another embodiment provides a processing device for selecting files conveniently. The processing device includes a processor and a display panel. The processor is used for receiving a first open command of a user, a browse command, a browse end command, a select command, a second open command, and a processing command. The processor opens a folder on the display panel according to the first open command, displays at least one file of the folder on the display panel according to the browse command, selects the file browsed by the user currently to a selected file list according to the select command, closes the folder displayed on the display panel according to the browse end command, opens a selected file list on the display panel according to the second open command, and processes all selected files of the selected file list according to the processing command.

The present invention provides a processing device for selecting files conveniently and method thereof. In the processing device and the method, a user utilizes a selection button of software provided by the processing device to select at least one file of a folder to a selected file list. Then, the user utilizes a processing button to process all selected files of the selected file list simultaneously. Therefore, compared to the prior art, the present invention can quickly and conveniently select and process files of the folder, instead of requiring frequent switching between the software and a browser of the processing device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a processing device for selecting files conveniently according to an embodiment.

FIG. 2 is a diagram illustrating a selection icon, a processing button, and a file of a folder browsed by the user.

FIG. 3 is a diagram illustrating the selected file list after being unfolded.

FIG. 4 is a flowchart illustrating a method for selecting files conveniently according to another embodiment.

### DETAILED DESCRIPTION

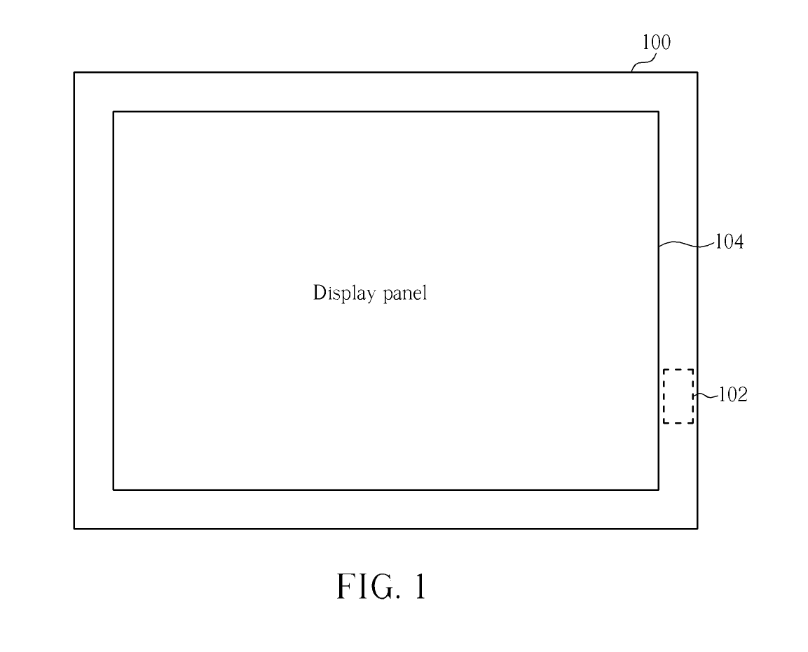

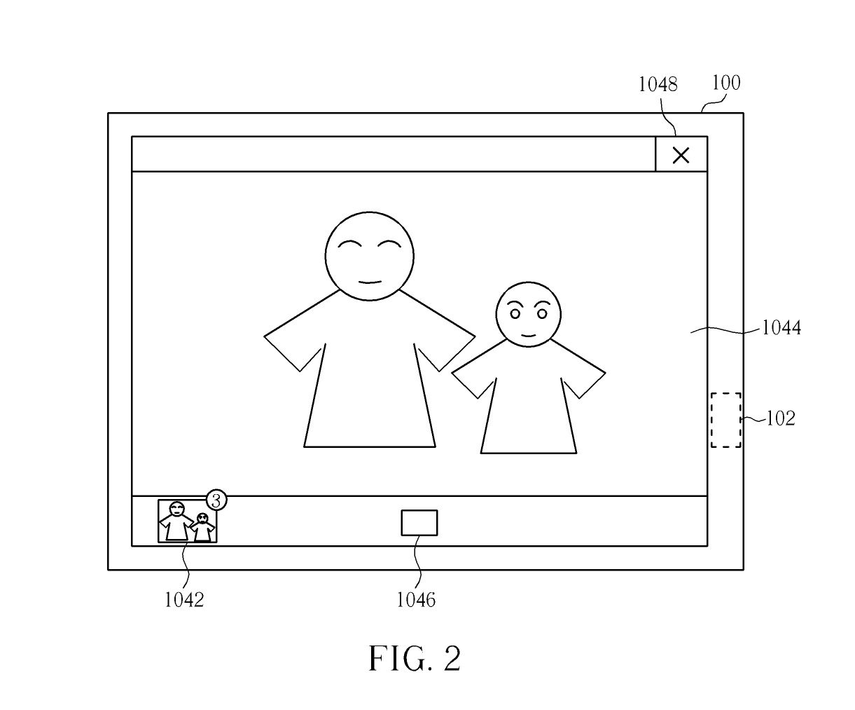

Please refer to FIG. 1 and FIG. 2. FIG. 1 is a diagram illustrating a processing device 100 for selecting files conveniently according to an embodiment, and FIG. 2 is a diagram illustrating a selection icon, a processing button, and a file of a folder browsed by a user, where the processing device 100 can be a tablet computer, a smart phone, a notebook computer, a personal digital assistant, or a desktop computer. As shown in FIG. 1, the processing device 100 includes a processor 102 and a display panel 104. The processor 102 is used for receiving a first open command of the user, a browse command of the user, a browse end command of the user, a select command of the user, a second open command of the user, a processing command of the user, and executing corresponding operations according to the first open command of the user, the browse command of the user, the browse end command of the user, the select command of the user, the second open command of the user, and the processing command of the user. After the user clicks a folder in software provided by the processing device 100 to generate the first open command, the processor 102 can open the folder on the display panel 104 according to the first open command. After the folder is opened, the processor 102 can display at least one file of the folder on the display panel 104 (such as a current browsed file 1044 as shown in FIG. 2) according to the browse command of the user (that is, the user can click a thumbnail of the at least one file of the folder to generate the browse command), where the at least one file of the folder is a picture, a text file, a virtual file, or a video file. In addition, when the processor 102 displays the at least one file of the folder on the display panel 104 according to the browse command of the user, the user can still store a new file to the folder, and utilize the software provided by the processing device 100 to continuously browse files of the folder.

When the user wants to further process the current browsed file 1044 displayed on the display panel 104, the user can click a selection button 1046 of the software to generate the select command. Of course, the selection button 1046 can be a button icon or a hot key. Then, the processor 102 can select the current browsed file 1044 to a selected file list 1042 according to the select command, so the selected file list 1042 is shown in the software. That is to say, if the selected file list 1042 does not have any selected file, the selected file list 1042 is hidden in the software. But, after the user selects the current browsed file 1044 displayed on the display panel 104, the user can click the selection button 1046 again to cancel the select command. Thus, the processor 102 does not select the current browsed file 1044 to the selected file list 1042. After the user finishes browsing the folder, the user can utilize an end button 1048 of the software to generate the browse end command. Then, the processor 102 can close the folder displayed on the display panel 104 according to the browse end command. In addition, the selected file list 1042 is the selection icon of the software (as shown in FIG. 2) before the selected file list 1042 is unfolded, where the selection icon displays a number of selected files (as shown in FIG. 2, the number is 3), and displays a thumbnail of a previous file selected by the user. But, the present invention is not limited to the number of the selected files displayed by the selection icon being 3, and not limited to the selection icon displaying the thumbnail of the previous file selected by the user. That is to say, the selection icon can display a thumbnail of any selected file of the selected files. In addition, in another embodiment of the present invention, the selection button 1046 can also be a hidden button. Therefore, the select command can be generated by the user when the user clicks any position of the current browsed file 1044, and the select command can be cancelled by the user when the user clicks any position of the current browsed file 1044 again.

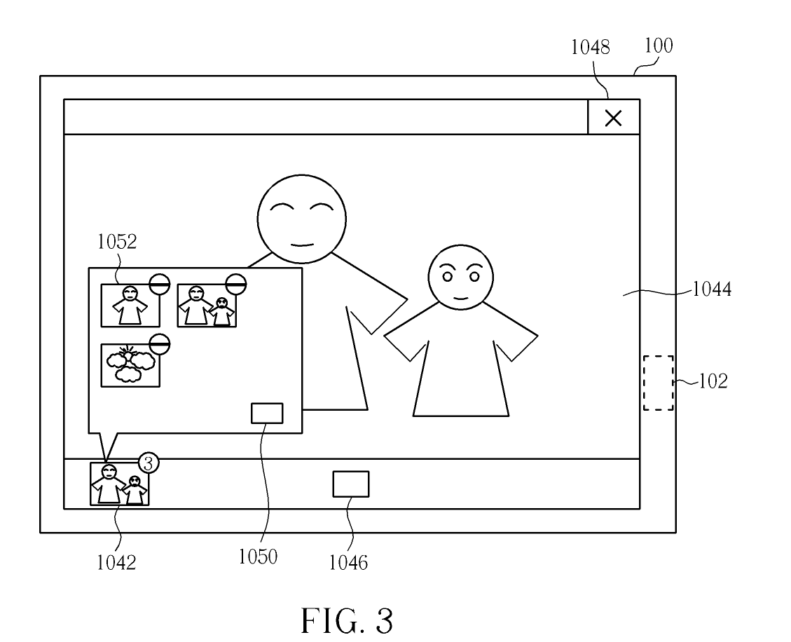

Please refer to FIG. 3. FIG. 3 is a diagram illustrating the selected file list 1042 after being unfolded. As shown in FIG. 3, the user can click the selection icon of the software (as shown in FIG. 2) to generate the second open command. Then, the processor 102 can open the selected file list 1042 on the display panel 104 according to the second open command, where the user can click the selection icon of the software again to cancel the second open command. Then, the processor 102 can close the selected file list 1042 on the display panel 104. As shown in FIG. 3, the selected file list 1042 includes thumbnails of the selected files after the selected file list 1042 is unfolded. The user can utilize a processing button 1050 to generate the processing command after the selected file list 1042 is unfolded, where the processing command can be a clip command, an edit command, an upload command, a store command, or a share command (for example, the user utilizes the share command to upload a file to the Internet). But, the present invention is not limited to the processing command being the clip command, the edit command, the upload command, the store command, or the share command. That is to say, the processing command can also be another processing command well-known by those skilled in the art. Then, the processor 102 can process all selected files of the selected file list 1042 simultaneously according to the processing command. For example, when all the selected files of the selected file list 1042 are video files, the user can utilize the processing button 1050 to generate the processing command (the clip command and the upload command). Then, the processor 102 can clip all the selected files of the selected file list 1042 simultaneously and upload a clipped result to video websites after all the selected files of the selected file list 1042 are clipped according to the clip command and the upload command. For example, when all the selected files of the selected file list 1042 are pictures, the user can utilize the processing button 1050 to generate the processing command (the edit command and the upload command). Then, the processor 102 can edit all the selected files of the selected file list 1042 simultaneously and upload an edited result to album websites after all the selected files of the selected file list 1042 are edited according to the edit command and the upload command. As shown in FIG. 3, each selected file of the selected file list 1042 has a Θ button. For example, when the user wants to delete a selected file 1052 of the selected file list 1042, the user can click a Θ button of the selected file 1052 to delete the selected file 1052 from the selected file list 1042.

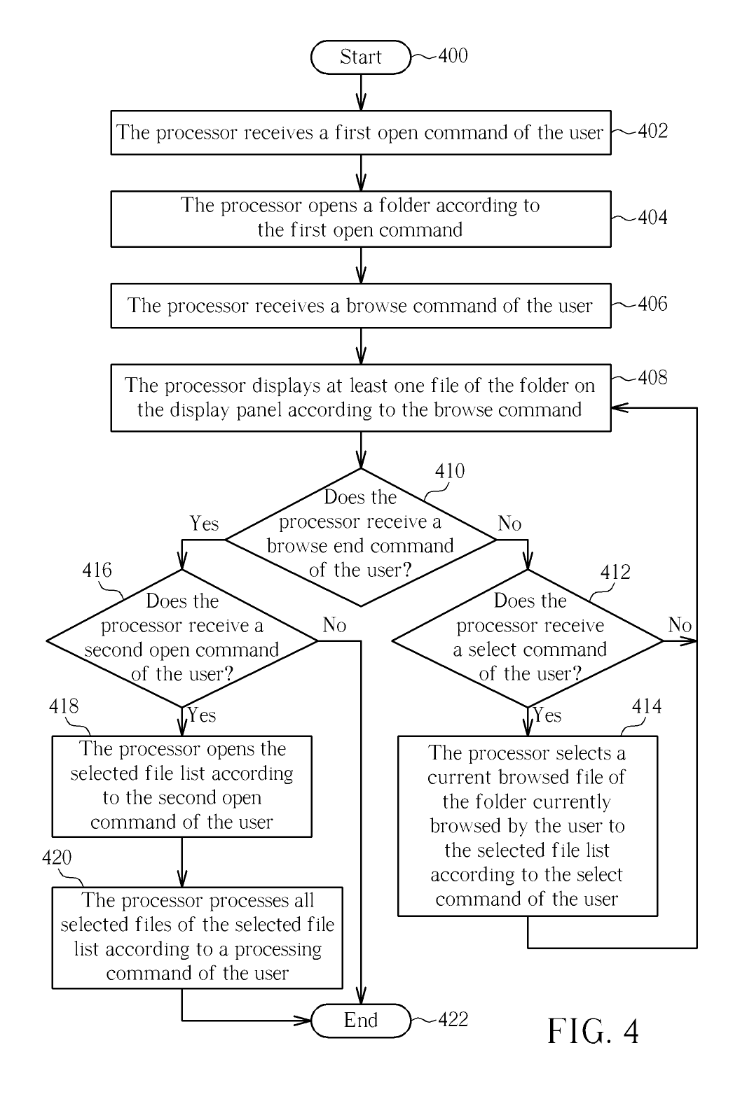

Please refer to FIG. 1, FIG. 2, FIG. 3, and FIG. 4. FIG. 4 is a flowchart illustrating a method for selecting files conveniently according to another embodiment. The method in FIG. 4 is illustrated using the processing device 100 in FIG. 1. Detailed steps are as follows:

Step 400: Start.

Step 402: The processor 102 receives a first open command of the user.

Step 404: The processor 102 opens a folder according to the first open command.

Step 406: The processor 102 receives a browse command of the user.

Step 408: The processor 102 displays at least one file of the folder on the display panel 104 according to the browse command.

Step 410: Does the processor 102 receive a browse end command of the user? If no, go to Step 412; if yes, go to Step 416.

Step 412: Does the processor 102 receive a select command of the user? If yes, go to Step 414; if no, go to Step 408.

Step 414: The processor 102 selects a current browsed file 1044 of the folder currently browsed by the user to the selected file list 1042 according to the select command of the user; go to Step 408.

Step 416: Does the processor 102 receive a second open command of the user? If yes, go to Step 418; if no, go to Step 422.

Step 418: The processor 102 opens the selected file list 1042 according to the second open command of the user.

Step 420: The processor 102 processes all selected files of the selected file list 1042 according to a processing command of the user.

Step 422: End.

In Step 402 and Step 404, after the user clicks the folder in the software provided by the processing device 100 to generate the first open command, the processor 102 can receive the first open command and open the folder on the display panel 104 according to the first open command. In Step 406 and Step 408, after the user clicks a thumbnail of at least one file of the folder to generate the browse command, the processor 102 can receive the browse command of the user and display the at least one file (such as the current browsed file 1044 shown in FIG. 2) on the display panel 104 according to the browse command of the user. In Step 414, when the user wants to further process the current browsed file 1044 displayed on the display panel 104, the user can click the selection button 1046 of the software to generate the select command. Then, the processor 102 can select the current browsed file 1044 to the selected file list 1042 according to the select command, resulting in the selected file list 1042 being shown in the software. That is to say, if the selected file list 1042 does not have any selected file, the selected file list 1042 is hidden in the software. In addition, after the user selects the current browsed file 1044 displayed on the display panel 104, the user can click the selection button 1046 again to cancel the select command. Thus, the processor 102 does not select the current browsed file 1044 to the selected file list 1042. After the user finishes browsing the folder, the user can utilize the end button 1048 of the software to generate the browse end command. Then, the processor 102 can close the folder displayed on the display panel 104 according to the browse end command. In Step 416 and Step 418, after the user finishes browsing the folder, if the selected file list 1042 is shown in the software (that is, the selected file list 1042 has at least one file selected by the user), the user can click the selection icon of the software (as shown in FIG. 2) to generate the second open command. Then, the processor 102 can open the selected file list 1042 on the display panel 104 according to the second open command. In addition, the user can click the selection icon of the software again to cancel the second open command. In Step 420, the user can utilize the processing button 1050 to generate the processing command after the selected file list 1042 is unfolded, where the processing command can be the clip command, the edit command, the upload command, the store command, or the share command. For example, the user can utilize the processing button 1050 to generate the processing command (the clip command and the upload command). Then, the processor 102 can clip all the selected files of the selected file list 1042 simultaneously and upload a clipped result to video websites after all the selected files of the selected file list 1042 are clipped according to the clip command and the upload command. For example, the user can utilize the processing button 1050 to generate the processing command (the edit command and the upload command). Then, processor 102 can edit all the selected files of the selected file list 1042 simultaneously and upload an edited result to album websites after all the selected files of the selected file list 1042 are edited according to the edit command and the upload command. In addition, as shown in FIG. 3, each selected file of the selected file list 1042 has a Θ button. When the user wants to delete a selected file 1052 of the selected file list 1042, the user can click a Θ button of the selected file 1052 to delete the selected file 1052 from the selected file list 1042.

To sum up, in the processing device for selecting files conveniently and the method for selecting files conveniently, the user utilizes the selection button of the software to select at least one file of a folder to the selected file list. Then, the user utilizes the processing button to process all selected files of the selected file list simultaneously. Therefore, compared to the prior art, the present invention can quickly and conveniently select and process files of the folder, instead of requiring frequent switching between the software and a browser of the processing device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for selecting files conveniently, the method comprising:
receiving a first open command of a user;
opening a folder according to the first open command;
receiving a browse command of the user;
displaying at least one file of the folder on a display panel according to the browse command; and
executing a corresponding operation according to whether a select command of the user is received when a browse end command of the user is not received.

2. The method of claim 1, wherein executing the corresponding operation according to whether the select command of the user is received comprises:
selecting a file currently browsed by the user to a selected file list according to the select command when the select command is received; and
browsing other files of the folder continuously according to the browse command.

3. The method of claim 2, wherein the selected file list is a selection icon of software before the selected file list is unfolded, and the selection icon displays a number of selected files.

4. The method of claim 2, wherein the selected file list comprises thumbnails of the selected files after the selected file list is unfolded.

5. The method of claim 1, wherein executing the corresponding operation according to whether the select command of the user is received comprises:
browsing other files of the folder continuously on the display panel according to the browse command when the select command is not received.

6. The method of claim 1, wherein the select command of the user is generated by the user through a selection button.

7. The method of claim 1, wherein the select command of the user is generated by the user through clicking any position of a file currently browsed by the user.

8. The method of claim 1, wherein the at least one file of the folder is a picture, a text file, or a video file.

9. A method for selecting files conveniently, the method comprising:
receiving a first open command of a user;
opening a folder according to the first open command;
receiving a browse command of the user;
displaying at least one file of the folder on a display panel according to the browse command; and
executing a corresponding operation according to whether a second open command of the user is received when a browse end command of the user is received.

10. The method of claim 9, wherein executing the corresponding operation according to whether the second open command of the user is received comprises:
opening a selected file list according to the second open command of the user.

11. The method of claim 10, further comprising:
processing all selected files of the selected file list according to a processing command of the user.

12. The method of claim 11, wherein the processing command is a clip command, an edit command, an upload command, a store command, or a share command.

13. The method of claim 11, wherein the processing command is generated by the user through a processing button.

14. The method of claim 10, wherein the selected file list is a selection icon of software and the selection icon displays a number of selected files before the selected file list is unfolded.

15. The method of claim 10, wherein the selected file list comprises thumbnails of the selected files after the selected file list is unfolded.

16. A processing device for selecting files conveniently, the processing device comprising:
a processor for receiving a first open command of a user, a browse command, a browse end command, a select command, a second open command, and a processing command; and
a display panel, wherein the processor opens a folder on the display panel according to the first open command, displays at least one file of the folder on the display panel according to the browse command, selects the file browsed by the user currently to a selected file list according to the select command, closes the folder displayed on the display panel according to the browse end command, opens a selected file list on the display panel according to the second open command, and processes all selected files of the selected file list according to the processing command.

17. The processing device of claim 16, wherein the select command is generated by the user through a selection button.

18. The processing device of claim 16, wherein the at least one file is a picture, a text file, or a video file.

19. The processing device of claim 16, wherein the selected file list is a selection icon of software before the selected file list is unfolded, and the selection icon displays a number of selected files.

20. The processing device of claim 16, wherein the selected file list comprises thumbnails of the selected files after the selected file list is unfolded.

21. The processing device of claim 16, wherein the processing command is a clip command, an edit command, an upload command, a store command, or a share command.

22. The processing device of claim 16, wherein the processing command is generated by the user through a processing button.
